(19) United States
(12) Patent Application Publication
(10) Pub. No.: US 2006/0029759 A1
(43) Pub. Date: Feb. 9, 2006

(54) Bi-directional substrate design for aircraft escape slide airbeams

(75) Inventors: Mark A. Hannigan, Wakefield, MA (US); Charles A. Howland, Temple, NH (US)

Correspondence Address: MAINE & ASMUS, 100 MAIN STREET, P O BOX 3445, NASHUA, NH, 03061-3445, US

(73) Assignee: WARWICK MILLS, INC., New Ipswich, NH (US)

(21) Appl. No.: 11/198,621

(22) Filed: Aug. 5, 2005

Related U.S. Application Data
(60) Provisional application No. 60/599,932, filed on Aug. 9, 2004.

(51) Int. Cl. B60R 21/16

(52) U.S. Cl. 428/36.1

(57) ABSTRACT

A coated, bi-directional substrate design for an aircraft escape slide airbeam, where the longitudinal strength and hoop strength of the substrate and the coating applied thereto are optimized to the application. Less than 45% of the total substrate fiber content is in the longitudinal direction of the substrate, and the longitudinal strength of the substrate is approximately 50% of the hoop strength. The substrate is constructed of nylon, polyester, aramid, para-aramid or liquid crystal polymer fibers, and either polyurethane coatings and adhesives or polyether polyurethane coatings and adhesives. The warp yarns are less than ½ the denier of the fill yarns and are woven in groups of 2 or more yarns to improve the tear strength of the fabric in the warp direction.

This invention relates and claims priority to pending U.S. application Ser. No. 60/599,932 filed Aug. 09, 2004.

### BACKGROUND OF THE INVENTION

1. Technical Field of the Invention

The invention relates to inflatable aircraft escape slides, and in particular to fabrics with which such slides are constructed.

2. Background Art

Federal aviation safety regulations require aircraft to provide escape provisions for passengers in the event an emergency landing is required. The hardware systems built for this purpose have been in place since the late 1960's. The primary hardware system used for this purpose is an inflatable escape slide.

Inflatable escape slides are built from an assembly of inflatable air beams. The air beams are constructed from coated nylon fabrics and have a typical fabric weight of 7.5 ounces per square yard. In total, the fabric used in the escape slide system comprises 65 lbs, equal to 30% of the total escape slide system weight. Hardware and mechanisms for deploying the escape slide system comprise the balance of the system weight.

The escape slide system is constructed in a pontoon configuration using parallel 25 inch diameter air beams spaced approximately eight feet apart. The main airbeams are connected with cross airbeams of similar or smaller diameter. On top of the airbeam construction is a slide fabric designed as the sliding surface for the passenger. The slide surface must have low friction to reduce heat to the passenger and must also be adequately conductive to avoid static charge build up during the sliding event.

The airbeams are constructed from multiple pieces of coated fabric and joined together by various methods including thermoplastic heatseal. The heatseal method uses a combination of temperature, pressure and dwell time to thermoplastically weld two or more adjacent pieces of coated fabric. This technology eliminates the complexity and cost of mechanical stitching previously used.

To improve the operating efficiency of aircraft there is continuous demand for weight reduction in the components used in the manufacture of the aircraft. Weight reductions of 20% or more are necessary to meet the operating goals of the 21^{st} century airliners. For the escape slide systems, a reduction in fabric weight of 20% or more is necessary without compromising the performance requirements of the escape slide system.

The airbeam fabrics used throughout the industry are highly specified. Requirements for these fabrics include air holding capacity at inflation pressures of 3-5 psi, tensile strength to support the loads due to inflation pressure and resistance to failure due to tear, puncture, tear propagation, chemical fluids, hydrolysis, mildew, flame, abrasion, and aging. Joined fabric pieces are additionally tested for seam peel, tensile and shear strength.

Although the fabric provides the fundamental mechanical properties of the airbeam, the coating systems have been the focus of development over the years to improve chemical and heat resistance of the finished product. Innovation in the coating systems has evolved to the current state of art using a 3.5 oz/yd² polyether polyurethane coating system on a 4.0 oz/yd² nylon fabric produced from 210 denier fiber. The total coated fabric weight currently averages approximately 7.5 oz/yd². The base fabric design is described as follows:

| | |
|---|---|
| Warp: | 210 denier Nylon 6,6 @ 78 ends / inch |
| Fill: | 210 denier Nylon 6,6 @ 68 ends / inch |

This standard approach allocates 53% of the fiber mass to the longitudinal axis of the airbeam and 47% of the fiber mass to the hoop direction of the airbeam. The ratio of hoop strength (H) to longitudinal strength (L) is H/L=0.9.

The aviation industry is a highly regulated industry where government approved specifications for aircraft components tend to inhibit gradual development and improvements and recognize only quantum steps that will justify revisiting the regulatory process. The specific matter of the inflatable aircraft escape slides has not been seriously addressed in many years, and is clearly in need of serious analysis to accomplish the larger goals of the industry. A fresh analysis and new design is disclosed here which allows the reduction in fabric mass while maintaining the required strength in the airbeam in both the radial and longitudinal directions.

### SUMMARY OF THE INVENTION

A primary object of the invention is to provide lighter and cheaper fabrics for manufacturing the aircraft escape slide airbeams.

Another object of the invention is to provide a fabric that has different strengths in longitudinal and hoop directions.

A further object of the invention is to provide a fabric that has different weaving density in longitudinal and hoop directions.

The claimed invention discloses a fabric capable of using in an aircraft escape slide airbeam. The fabric has at least one warp fiber and at least one fill fiber woven with the warp fibers. The warp fibers and the fill fibers provide a longitudinal strength in a longitudinal direction and a hoop strength in a hoop direction. The longitudinal strength is smaller than the hoop strength.

The claimed invention also discloses a fabric capable of using in an aircraft escape slide airbeam. The fabric has a plurality of warp fibers and a plurality of fill fibers woven with the warp fibers. The warp fibers and the fill fibers provide a longitudinal strength in a longitudinal direction and a hoop strength in a hoop direction. The longitudinal strength substantially half of the hoop strength.

The claimed invention further discloses a fabric capable of using in an aircraft escape slide airbeam. The fabric is composed of a plurality of fibers and constructed in a bi-directional manner such that less than 45% of a total fabric fiber content is in a longitudinal direction of the fabric.

Still other objects and advantages of the present invention will become readily apparent to those skilled in this art from the following detailed description, wherein I have shown and described only a preferred embodiment of the invention, simply by way of illustration of the best mode contemplated by me on carrying out my invention. As will be realized, the invention is capable of other and different embodiments, and its several details are capable of modifications in various obvious respects, all without departing from the invention.

### BRIEF DESCRIPTION OF THE DRAWINGS

FIGS. 1A and 1B are a pie chart comparison of force in the longitudinal and hoop directions.

FIG. 2 is a table of fabric weight efficiency.

FIG. 3 is a table comparing fiber type and fabric cost.

FIGS. 4A, 4B and 4C are schematic diagrams showing various fiber cross-sectional shapes.

FIG. 5 is a table showing height and width dimensions by fiber cross-section shape.

FIG. 6 is a schematic diagram of woven fabric cross-section.

FIG. 7 is a table showing thickness reduction by fiber substitution.

FIG. 8 is a chart showing average fiber pitch for warp and fill yarns based on denier and a target fabric weight.

FIG. 9 is a chart of balanced fabric cover factor.

FIG. 10 is a table showing optimum denier by fabric weight for balanced fabric constructions.

FIG. 11 is a chart showing 2:1 bi-directional fabric cover factor by fabric weight.

FIG. 12 is a chart showing warp shed cover factors for 2:1 bi-directional fabrics.

FIG. 13 is a chart showing 2:1 denier ratio for 2:1 bi-directional fabrics.

### DESCRIPTION OF THE PREFERRED EMBODIMENT

Bi-Directional Design

The airbeam is a circular tube construction. The inflated airbeam in a conventional aircraft slide application does not have equal stresses in both fabric directions. Specifically, the strength requirements along the length of the tube are about one half that across the diameter of the tube. This is due to the relatively high loads generated by the air pressure inflating the airbeam and how they are translated into the airbeam fabric load in order to assure adequate structural rigidity as a bridge between the aircraft and the ground under the weight of the slide and the passengers using it.

The load on an airbeam fabric due to inflation is calculated using the tube pressure and projected area of the beam cross section in the direction of pressure. Across the diameter of a tube (hoop direction), the projected area is the diameter the tube times the unit length of interest. The load on the fabric will be shared equally between the top and bottom of the airbeam, such that the hoop load on the fabric (per inch) is calculated:
Fₕₒₒₚ=P*D/2
where Fₕₒₒₚ is Hoop Strength, P is Pressure, and D is Hoop Diameter.

A typical airbeam is 25″ in diameter and operates at approximately 3.5 psi. The operating load on the fabric is therefore 3.5*25/2=44 lbs/inch.

In the longitudinal direction of the tube, the projected area on which the pressure acts is the circular area at the end of the tube. This pressure is distributed around the circumference of the tube. Hence longitudinal strength requirement of the fabric is:
F_{long}=P*(πD²/4)/(πD0
F_{long}=P*D/4
where F_{long} is the longitudinal strength of the airbeam.

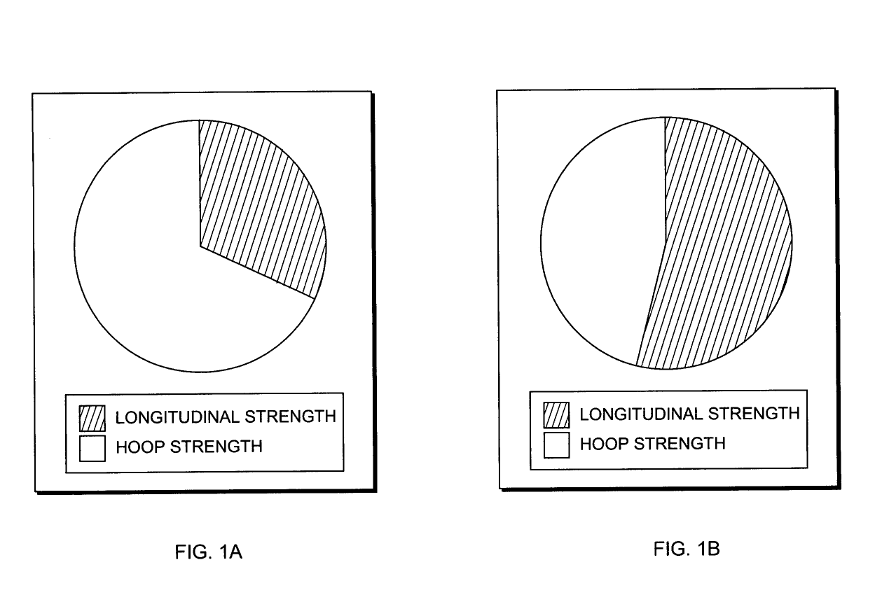

Please refer to FIGS. 1A and 1B, which is a pie chart comparison of force in the longitudinal and hoop directions between one embodiment of the invention, FIG. 1A, and a contemporary airbeam fabric, FIG. B. For a 25″ tube under 3.5 psi the force in the longitudinal direction is half that of the hoop direction or 22 lbs/inch. This equates to a hoop force ratio or required hoop strength ratio:
H/L=2

This analysis leads to the insight that the fabric requirements for an airbeam do not require balanced fabric properties. Tubular airbeams require bi-directional properties, or properties that are different in the warp than the fill. Designing the fabric such that the warp strength is one half the strength of the filling reduces the standard airbeam fabric construction from, for example, 78×68 to 34×68, gaining a valuable fabric weight reduction of about 30%.

This novel approach in substrate design for aircraft airbeams allows for a fabric weight reduction using standard low cost nylon fibers. Although there is a 30% reduction in the weight of the base fabric, since it only comprises 53% of the total fabric system weight we have only reduced the fabric system weight by 16%. While this is significant and valuable in and of itself, the goal of yet further reduction in total composite weight must come from a reduction in coating quantity of at least about 10%.

Weight Efficiency

By applying the bi-directional fabric design strategy to airbeam composites, the overall system weight efficiency improves dramatically.

Based on a minimum FAA safety factor of 4.0, for a nylon fabric of 7.5 grams per denier it can be shown the optimum weight rating is approximately 32 pounds of load per ounce of fabric in the direction of load. Based on this standard, a fabric using high tenacity nylon with a weight efficiency factor of 10.4 lbs/oz in one direction, has a weight efficiency of 33% in that direction.

By designing the airbeam fabric with the appropriate fiber content based on the inflation forces applied to the fabric, the weight efficiency can be improved dramatically. Using the bi-directional fabric design, a lower grade 100d nylon fiber can be used to obtain weight efficiencies in the 60-80% range based on safety factors of 4.0-5.3.

Extreme improvements can be made by using high tenacity liquid crystal polymer fibers such as vectran. Using vectran and weight efficiency greater than 70 can be obtained using a fabric<1.0 oz/yd². Details are shown in the table below. This degree of improvement can be very costly due to the higher fiber costs and may not be commercially justified unless or until changes occur in relative cost of materials and/or fuel. It none-the-less illustrates the power and range of the invention for achieving weight reduction while maintaining performance requirements.

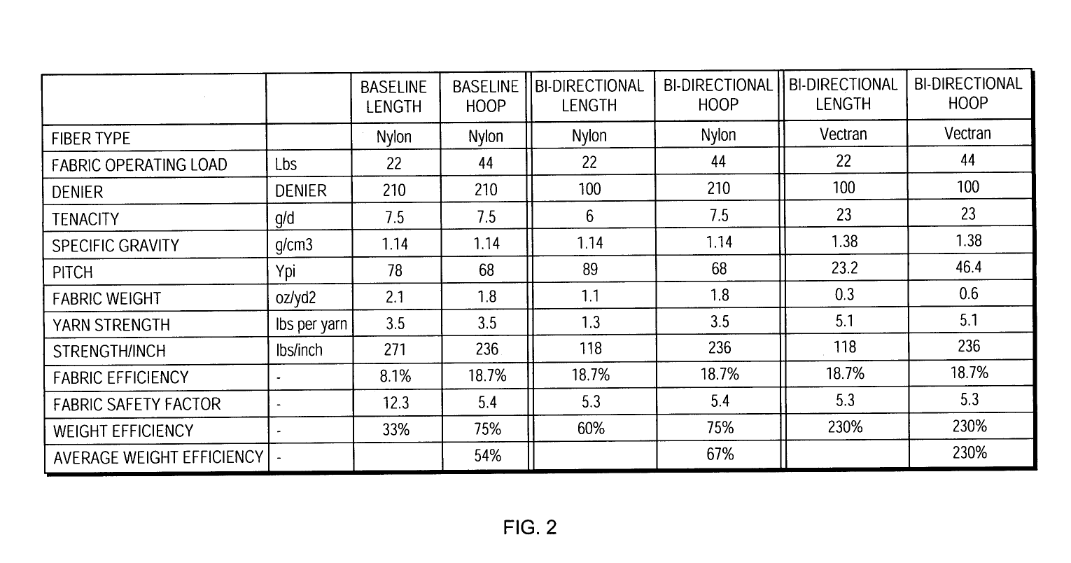

FIG. 2, is a table of fabric weight efficiency comparing a bi-directional Nylon embodiment and a bi-directional Vectran embodiment to the baseline nylon fabric commonly used today. As indicated, weight efficiencies in excess of 200% are realizable using selected materials assembled in a bi-directional mode that is tailored to the specific airbeam requirement.

Hoop Strength Metric

Airbeam fabric properties are most critical in the hoop direction of the airbeam construction. A measure of a fabric design performance is based on the operating load ratio to the fabric weight. For hoop load capacity of 240 lbs, a 7.5 oz composite fabric has a hoop load rating (HLR) as follows:
HLR=240/7.5=32lbs/oz

Using bi-directional fabric technology with a 6.0 oz composite fabric the HLR:
HLR₆=240/6.0=40lbs/oz

Further refinements are possible with higher modulus fibers, including 5.0 oz, 4.0 oz and 3.0 oz fabrics such the hoop load ratio increases as follows:
HLR₅=240/5.0=48
HLR₄=240/4.0=60
HLR₃=240/3.0=80
Fiber Cost

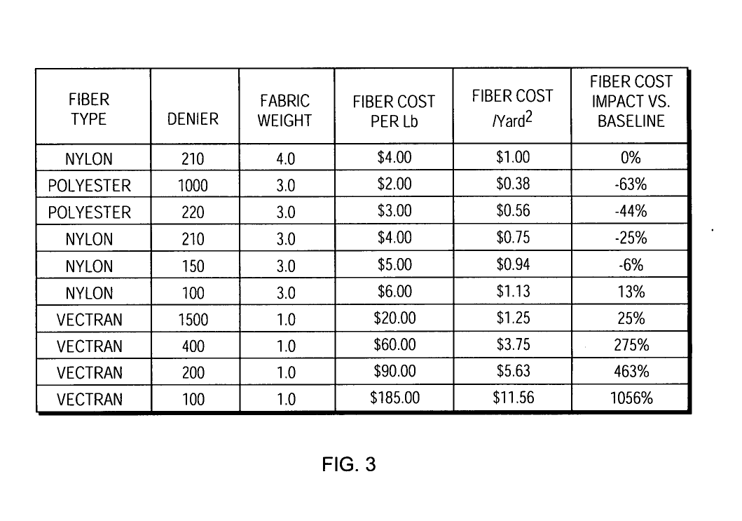

In accordance with the invention, a weight reduction of 20% can be easily achieved by substituting high strength fibers used in inflatable composites such as Vectran. The main obstacle in this approach is the significant impact on the relative cost of suitable materials. While fine denier nylon fiber costs are presently in the $4.00-6.00/lb range, fine denier Vectran fiber costs are in the $90-$185/lb range. The weight and present costs of various materials alternatives are illustrated in the table of FIG. 3. Ultimately, other economic factors such as increasing fuel costs or longer life cycles (more flight hours) over which initial costs may be amortized, may make the further available weight reductions more attractive or compelling.

Composite Thickness

In our pursuit of weight reduction of the coated fabric composite of airbeam structures and devices, various strategies can be used including reducing the fabric weight exclusively, reducing the coating weight exclusively, or reducing both the fabric and the coating weight in proportions viable for the intended purpose. Independent of the design strategy, weight reduction of the airbeam structure requires the overall composite thickness of the fabric component to be reduced by an amount proportional to the total weight change and the average material density.

In theory, the coated fabric should be produced as a nearly void-free structure to ensure it is impermeable to air and provides fiber adhesion for sufficient seam strength. Voids in the fabric structure are stress concentration points and will nucleate into larger voids producing pin holes and/or fiber slippage causing seam failure. A void free composite can be obtained only if net composite thickness meets a minimum thickness value established by the mass and density of the fiber and coating materials used.

Based on the standard airbeam composite fabric (4.0 oz/yd² fabric, 3.5 oz/yd² aromatic polyether polyurethane coating), the optimum (void-free) composite thickness can be calculated based on a theoretical compressed fabric and coating thickness.

The compressed fabric thickness (net) is based on the fabric being compressed fully to match the specific gravity of the fiber. This is not a fully realistic value but useful in combination with a coating quantity in calculating a theoretical, void-free composite thickness.

| Fiber specific gravity (nylon) | ρ_{f} = 1.14 g/cm³ | = 0.658 oz/in³ |
|---|---|---|
| Fabric unit weight | w_{f} = 4.0 oz/yd² | = 0.00309 oz/in² |
| Allowable net fabric thickness | | = .00309 / 0.658 |
| | | = 0.0047″ |
| Coating specific gravity (urethane) | ρ_{c} = 1.2 g/cm³ | = 0.693 oz/in³ |
| Coating unit weight | w_{c} = 3.5 oz/yd² | = 0.00270 oz/in² |
| Allowable net coating thickness | | = .00270 / 0.693 |
| | | = 0.0039″ |

Combining the allowable net fabric and coating thicknesses, the optimum composite thickness is estimated at 0.0086″. At a maximum load tensile strength of 44 pounds/inch, the maximum hoop strength requirement of the airbeam becomes 5100 psi. Using a minimum FAA safety factor of 4, the composite material requirements become 20,400 psi.

In practice, the actual composite thickness is rarely produced to the optimum (minimum) thickness due to various processing constraints. Based on an minimum composite thickness of 0.0086″, a composite with actual thickness of 0.012″ would have a void content of 28%. This does not affect the weight of the composite but may affect the mechanical, chemical and thermal properties of the composite.

As a result, a 20% reduction in coating weight requires a composite thickness reduction of 0.0017″ for a target composite thickness of less than 0.0069″ for this application.

Having determined a bi-directional fabric design can be used based on load patterns for tubular airbeam, a fabric weight of 2.80 oz/yd² is practical (30% reduction in fabric weight). The corresponding 10% coating reduction allows a maximum coating weight of 3.15 oz/yd². Based on these constituent weight targets, the minimum composite thickness would be 0.0068″ as shown below:

| Fiber specific gravity (nylon) | ρ_{f} = 1.14 g/cm³ | = 0.658 oz/in³ |
|---|---|---|
| Fabric unit weight | w_{f} = 2.8 oz/yd² | = 0.00216 oz/in² |
| Allowable net fabric thickness | | = .00216 / 0.658 |
| | | = 0.0033″ |
| Coating specific gravity (urethane) | ρ_{c} = 1.2 g/cm³ | = 0.693 oz/in³ |
| Coating unit weight | w_{c} = 3.15 oz/yd² | = 0.00243 oz/in² |
| Net coating thickness allowed | | = .00243 / 0.693 |
| | | = 0.0035″ |

Combining the optimum fabric and coating thicknesses, yields a minimum possible composite thickness of 0.0068″. For a hoop strength rating of 240 lbs/inch, a 6 oz fabric will yield a hoop load rating of 40 lbs /oz of fabric. At a tensile strength of 44 pounds/inch, the hoop stress requirement of the airbeam increases to 6,500 psi. Using a minimum FAA safety factor of 4, the composite material requirements become 26,000 psi.

Further consideration must be given to changes in fiber and coating chemistry to account for different material densities than shown above. For example, an aromatic polyurethane coated polyester fabric would have a target thickness of 0.0063″. Substituting an aliphatic polyurethane would reduce the target thickness to less than 0.0058″ based on the higher specific gravity of aliphatic polyurethanes.

Fiber Geometry and Composite Thickness

To achieve an optimum composite thickness, the actual substrate thickness should be designed towards the total thickness rather than the net thickness allowed. Fully compressing the fabric to its “net” thickness allowed will degrade fabric properties in tensile and tear and hence provide a sub-optimum substrate. It has been determined that the target thickness of the fabric prior to coating is 80-95% of the optimum total thickness. In the example above, although the net fabric thickness based on mass and density is 0.0033″, the actual fabric thickness target would be 80-95% of the final coated thickness target of 0.0068″, or 0.0055″to 0.0065″.

A prediction of the actual fabric thickness can be made based on the fiber size, density and shape. Fiber size and density have been discussed. Fiber shape typically takes one of three shapes.

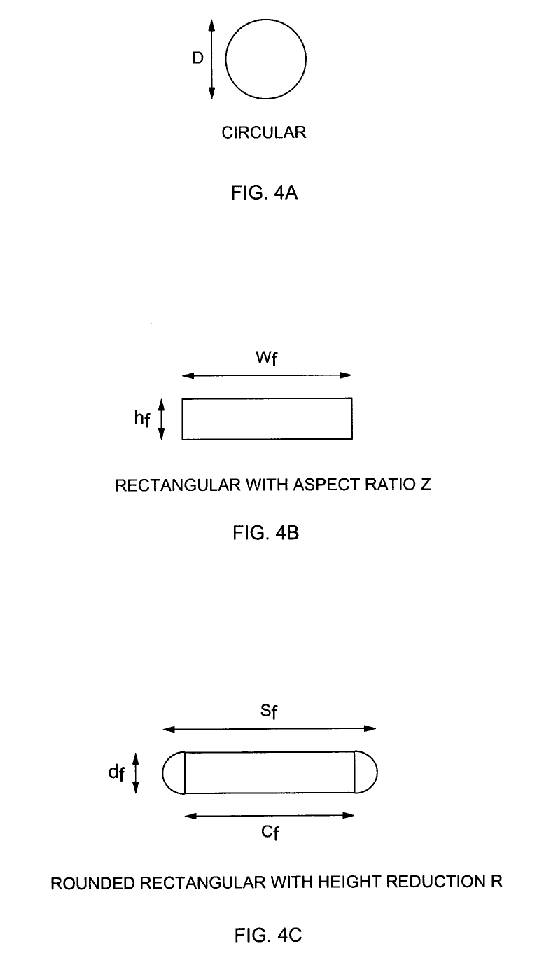

Referring now to FIGS. 4A-4C, there are illustrated schematic diagrams showing a selection of fiber or yarn cross-sectional models useful to the discussion. Producer packaged yarn typically has 0-0.5 turns of twist per inch and as a result is generally rectangular in cross section as in FIG. 4B. For woven fabrics where there is high fiber coverage in the warp, twist is applied to improve the abrasion resistance of the fiber. Twist also improves strength and tear resistance in fibers. Twisted yarn is modeled as circular in cross section as in FIG. 4A. A third cross section configuration of interest is rounded rectangular cross section as in FIG. 4C. This cross section can be produced by yarn air entanglement, for example, or by low twist or post-processing of a fabric such as by calendaring.

The rectangular cross sectional (RCS) fibers representative of flat filament producer yarns are lowest cost but can be susceptible to damage from abrasion since the fiber filaments are exposed for longer lengths along the surface of the fiber. Producer yarns are often used in the filling direction of fabrics. Cost effective air entangling methods are used to improve abrasion resistance of the fiber with slight modification to the fiber cross section, to produce the rounded rectangular cross section (RRCS) model. A circular cross sectional fiber (CCS) may also include spun staple yarn. CCS fibers are more abrasion resistant than RCS and RRCS fibers since each fiber filament is only intermittently located at a given radial axis along the yarn surface. A rounded rectangular (RRCS) cross section would also be representative of a fiber with low twist or a round twisted yarn reshaped by a calendaring process.

Each shape assumption for the fiber has a corresponding height and width basis for determining fabric thickness. For height and width for each cross sectional shape are shown below.

The cross sectional area independent of shape is related to fiber denier and density as follows:
A_{f}=Q/ρ/7.39E6
where A_{f} is cross section area, Q=yarn denier (g/9000 m), ρ=yarn specific gravity (g/cm³), and E is ???.

This relationship shows that denier is proportional to fiber area. Hence smaller deniers have less composite volume. The cross sectional dimensions for each cross sectional shape vary based on the shape assumptions.

Circular Cross Section:
Height=Width=D
D=SQRT((Q/ρ)/2136 (inches)
   where: Q=yarn denier (g/9000 m)
ρ=yarn specific gravity (g/cm³)
   For a 210 denier twisted nylon fiber, D=0.0064.

Rectangular Cross Section

Height=h_{f}; Width=w_{f}; related by aspect ratio Z:
w_{f}=Z*h_{f}
h_{f}=SQRT(Q/Z/ρ)/2720
w_{f}=SQRT(Z*Q/ρ)/2720
   For a 210 denier nylon producer fiber with an aspect ratio of 2:1, fiber height and width are:
Z=2 h_{f}=0.0035 w_{f}=0.0071

Rounded Rectangular Cross Section:

Height=d_{f}; Width=s_{f}

Height reduced from circular diameter (D) by a factor (R)
d_{f}=D/R
s_{f}=d_{f}+c_{f}
c_{f}=SQRT((Q/ρ)*(R−1/R))/2720
   For a 210 denier nylon twisted fiber calendered to reduce the fiber diameter by a factor of 2, fiber height and width are:
R=2 d_{f}=0.0032 s_{f}=0.0107

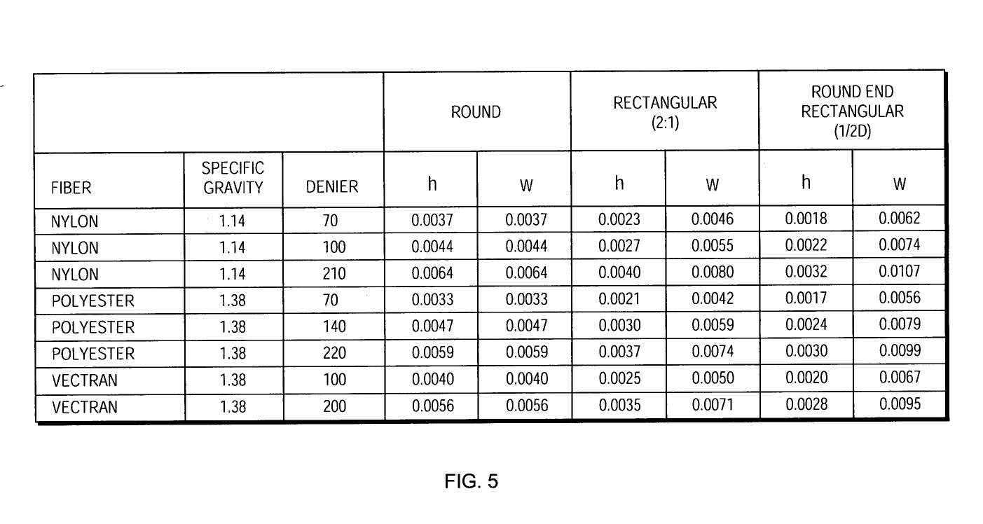

Examples of the height and width of round, rectangular and round rectangular fiber cross section dimensions are shown in the table of FIG. 5.

Fabric Thickness

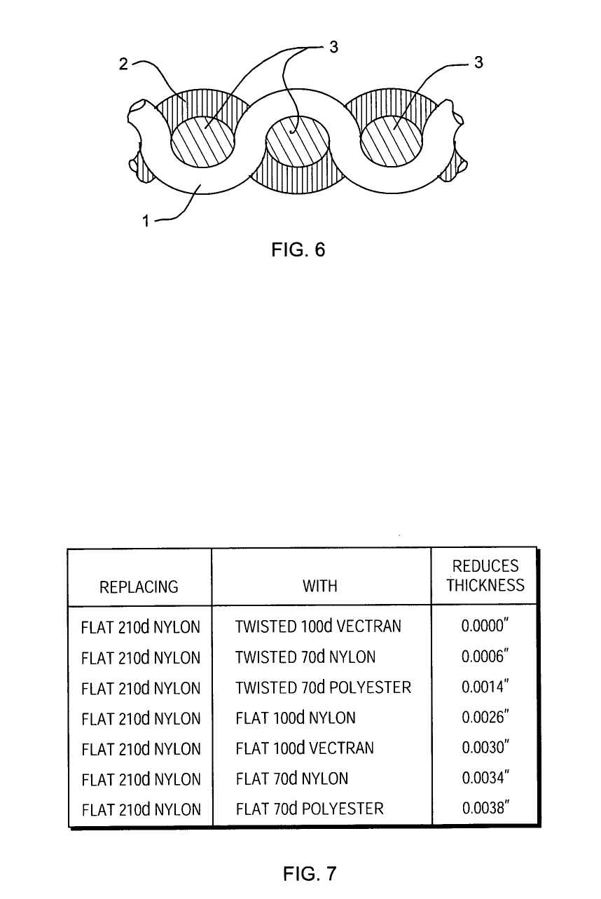

In a woven fabric the warp yarns are wrapped around the filling yarns typically in an alternating pattern. As a result, the fabric thickness is determined typically by the height of two warp yarns and one filling yarn as shown in FIG. 6, which is a schematic diagram of woven fabric cross-section.

This view is a cross section cutting filling yarns 3 to view the warp yarns 1 and 2 and their crimp. The yellow warp yarn 1 represents the first group of yarns while the green warp yarn 2 represents the second group of yarns where the group is defined as the number of yarns woven together. For a plain weave the group size of warp yarn 2 is 1; for a 2×1 basket the warp yarn 2 group size is 2, etc.

This diagram shows the thickness of the fabric is determined by two wrapping yarns (shown here as warp yarns) and one wrapped yarn (shown here as filling yarns). This view could similarly represent the view of warp yarns wrapped by filling yarns. The key point of the illustration is that the thicknesses of the three different yarns or yarn bundles make up the uncoated thickness of the fabric. This tends to make the selection of the higher crimp yarn, typically the warp yarn, most critical in determining fabric thickness, as it tends to count twice.

The current fabric is constructed of flat 210d nylon fibers in both the warp and the fill direction. From this analysis, although the strength requirements of the fabric are such that the warp strength can be reduced, a weight reduction cannot be achieved without a change to the fabric thickness, which, in turn requires a change to at least one of the fibers, preferably the warp yarn as it is counted twice to determine the fabric thickness.

To meet the weight reduction the fiber size also needs to be reduced. From the table in FIG. 7, which is a table of thickness reduction by fiber substitution, it can be shown that replacing a flat 210d warp yarn can yield the following thickness changes.

If both warp and fill fibers are replaced by the same fiber, the thickness reduction can be increased by 50%. A total thickness reduction target of 0.0018″ would allow the use of a low twist 100d nylon fiber to yield a thickness reduction in the base fabric of 0.0015-0.0025″.

The initial fiber shape may be altered to increase the aspect ratio to greater than 2 using pressure and temperature in a nip process including but not limited to a calendering machine.

Although the use of smaller denier yarns helps reduce the overall thickness, the fabric tear strength can be severely compromised as a result. To maintain adequate tear strength, the yarns need to be paired together in groups of yarn greater than the ratio between the original yarn denier and the new yarn denier. For example if a 210 denier yarn is replaced with a 70 denier yarn, yarns must be assembled in groups of three or more to preserve the basic tear characteristics of the fabric. Compensation for fiber tenacity should also be included in the group determination. These changes in weave patterns will affect fiber coverage in the fabric and influence final composite fabric properties.

Optimum Fiber Coverage for Airbeam Fabrics

Fiber coverage is a measure of weave pattern density and stability in the plane of the fabric. Fiber coverage is dependent on both fiber shape and fiber pitch (yarns per inch) and weave pattern (fiber grouping).

Warp and fill fiber cover factors are calculated as shown below:
FCF_{w}=(W_{w}*G_{w}+H_{f})*P_{w}/G_{w}
FCF_{f}=(W_{f}G_{f}+H_{w})*P_{f}/G_{f}
where: FCF=fabric cover factor in warp or fill direction
W=width of warp or fill yarn
H=height of warp or fill yarn
G=average group size in cover direction
P=pitch or yarns per inch in warp or fill direction

The maximum theoretical cover factor in the warp and fill directions is 100%. This is particularly true in the filling direction based on the process of yarn insertion. As filling yarns are inserted in the fabric, space for both the warp and fill yarn must be available.

Warp fabric cover factor is somewhat different. The warp cover fabric described above assumes one warp yarn and one fill yarn at each crossing point. The real process limitation for warp coverage however is based on warp shed coverage. The warp shed coverage need only consider size and pitch of the warp yarns since it is only the warp yarns which move during the harness motion of the weaving shed. The cover factor of the warp shed is:
SCF_{w}=W_{w}*P_{w}
where: SCF=warp shed cover factor in warp direction only

For warp fabric coverage CF_{w} less than 100%, there is adequate space between warp yarns for the filling yarns to fit in between and wrap around the warp yarns producing crimp in the filling yarn. As the warp fabric cover factor approaches and exceeds 100%, there is not adequate space between the warp yarns to fit fill yarns, hence the fill yarns do not fully wrap around the warp yarns. This creates a low filling crimp fabric. High sley fabrics as described in Howland's prior patents where the warp count is significantly higher than the filling count, can be created due to this effect. Traditional airbeam fabrics use this construction approach to a slight degree although the warp fabric cover factor does not exceed 100%. Bi-directional fabrics are the complete inverse of this design where the warp cover is reduced significantly to allow higher strength constructions in the filling direction.

From the fiber shape details above the cover factor for the standard airbeam fabric (78×68 plain weave construction with twisted 210d nylon) is:
FCF_{w}=(0.0064*1+0.0064)*78/1=99.8%
SCF_{w}=(0.0064*78)=49.9%
FCF_{f}=(0.0064*1+0.0064)*68/1=87.0%

From the fiber shape details above the cover factor for the standard airbeam fabric (78×68 plain weave construction with flat 210d nylon) is:
FCF_{w}=(0.008*1+0.04)*78/1=93.4%
SCF_{w}=(.008*78)=62.4%
FCF_{f}=(0.008*1+0.004)*68/1=81.6%

Replacing the 78-210d warp yarn with a 88-100d nylon yarn in groups of 3 changes the cover factors to:
FCF_{w}=(0.0055*3+0.004)*88/3=60.1%
SCF_{w}=(0.0055*88)=48.4%
FCF_{f}=(0.008*1+0.0027)*68=72.8%

Replacing the 78-210d warp yarn with a 105—twisted 70d polyester yarns in groups of 3 changes the cover factors to:
FCF_{w}=(0.0033*3+0.004)*105/3=48.7%
SCF_{w}=0.0033*105=34.7%
FCF_{f}=(0.008*1+0.0033)*68=76.8%
The lower cover factors allow for more flexible composites which improve the packing effectiveness of the airbeams prior to deployment.
Description of the Fabric Weight

Fabric weight, W is estimated as follows for of a given warp and fill denier and pitch (ypi),

$$\begin{matrix}W ( oz \text{/} {yd}^{2} ) = ( {d}_{w} * {p}_{w} + {d}_{f} * {p}_{f} ) / 7760 \\ W = ( 210 * 78 + 210 * 68 ) / 7760 \\ = 3.95 oz \text{/} {yd}^{2} .\end{matrix}$$

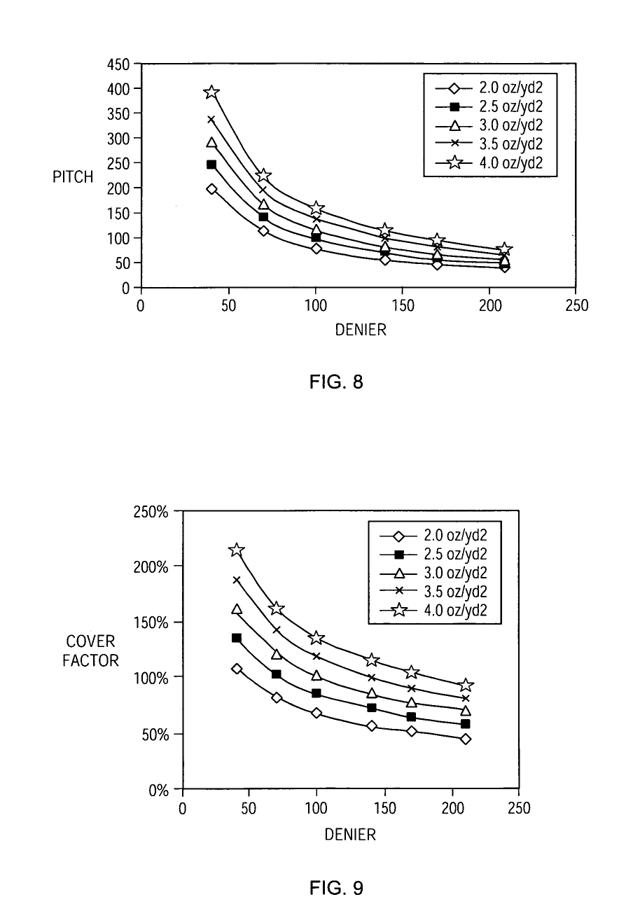

FIG. 8 is a chart of average fiber pitch (yarns per inch) for warp and fill yarns based on denier and a target fabric weight using the formula above.

Based on these pitch values a balanced plain weave fabric using the same denier in the warp and the fill would have fabric cover factors as shown in FIG. 9.

Using these pitch values by denier, the fabric cover factor can be calculated as shown in FIG. 9. The cover factors must be less than 100% to be a feasible construction in the filling direction. From FIG. 9, it is shown that producing a balanced 4.0 oz fabric requires a fiber size of 175 denier fiber or greater. Fibers less than this denier size require higher coverage factors than are practical in the filling direction for balanced fabrics.

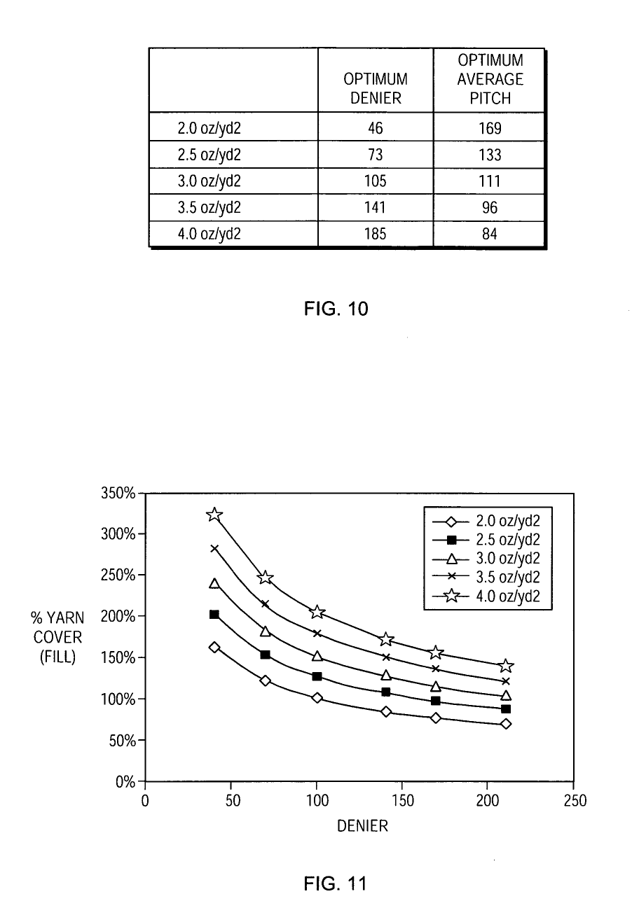

The optimum denier and pitch for 100% cover factor based on fabric weight can be calculated from the same relationship and is shown in FIG. 10, which is a table of optimum denier by fabric weight for balanced fabric constructions.

For bi-directional fabrics, the limiting cover factor is in the fill direction based on the higher proportion of filling yarn vs. warp yarn. Using equal fiber denier warp and fill in a 2:1 bi-directional fabric, the cover factors change as shown in FIG. 11.

Using a 2:1 bi-directional construction, a 4.0 oz fabric design cannot be produced with a 210d nylon fabric as it requires a fabric cover factor>140% in a plain weave construction. The maximum fabric weight using a 210 denier nylon fiber in a plain weave construction in a 2:1 bi-directional fabric is slightly less than 3.0 oz/yd². The optimum fiber size for a maximum cover plain weave fabric 2.5 oz/yd² is approximately 170 denier.

Unlike the balance fabric, the warp cover factor in a bi-directional fabric is one half the fill cover factor. Although the fill cover factors are increasing, the warp cover factors are reducing significantly which can create a fabric stability issue affecting airbeam performance under load.

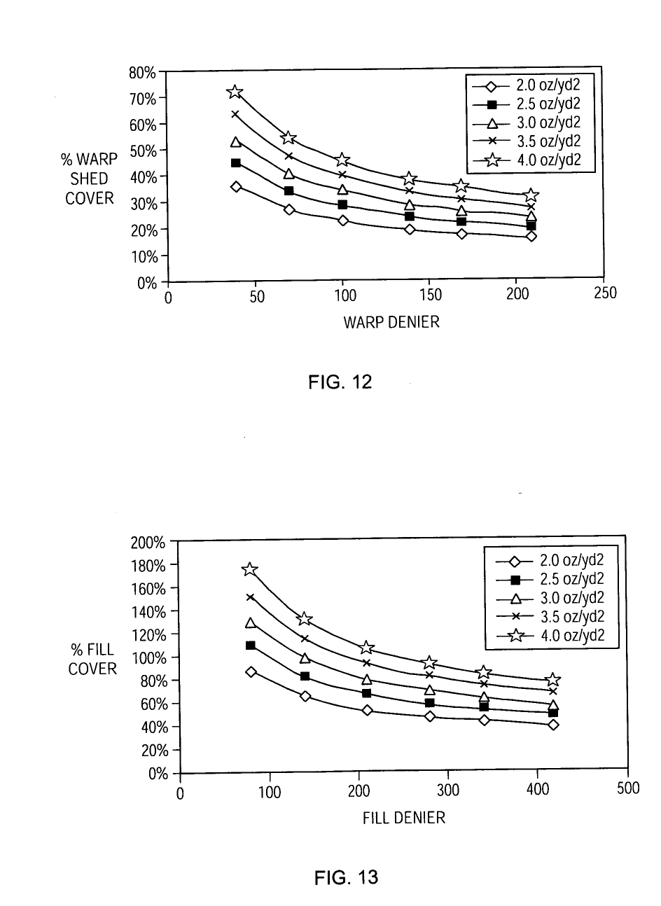

To increase the warp cover factor, smaller warp yarns may be used in higher quantity to improve weave stability. At the same time, smaller warp yarns will allow for the filling cover factors to be reduced, allowing more feasible constructions using larger deniers. Using a warp yarn denier equal to one half the filling yarn denier has the impact on warp shed and filling fabric cover factors as shown in FIG. 12 and FIG. 13.

Reducing the warp denier to be approximately one half of the filling denier allows the warp pitch to be increased to improve the warp shed coverage from 24% to 34%. This design also reduces the fabric cover factor in the filling direction from 94% full to 79% full, delivering equal performance with a more flexible construction. Alternatively, higher strength airbeams can be created since higher filling picks can be inserted. An 18% increase in airbeam fabric strength is attainable with 210d fiber allowing for higher pressure and/or larger diameter airbeam constructions to be produced.

One embodiment among the numerous useful embodiments within the scope of the invention is an aircraft escape slide airbeam coated fabric that is 20% lighter than contemporary coated fabrics presently employed, as described elsewhere herein. It may employ a bi-directional construction with longitudinal and lateral components, that are designed to provide proportional support corresponding to the calculated axial and hoop loads of the airbeam and may consist of warp and fill fibers and/or fiber bundles of different denier and/or end counts.

Among the numerous embodiments of the invention is an airbeam fabric for an aircraft escape slide or other inflatable, load bearing, beam-like structure and application, utilizing a bi-directional construction such as a bi-directional weave, such that less than 45% of the total fabric fiber content is in the longitudinal direction of the fabric. For example, approximately 33% of the total fiber content may be in the longitudinal direction of the fabric. The airbeam structure is configured with the fabric's longitudinal direction running lengthwise of the beam, so as to put the larger, remaining percent of fiber content in the lateral direction of the fabric, which will be the hoop direction of the airbeam.

The fabric may be constructed of nylon, polyester, aramid, para-aramid and/or liquid crystal polymer fibers and polyurethane coatings and adhesives. Or it may be constructed of nylon, polyester, aramid, para-aramid and/or liquid crystal polymer fibers and polyether polyurethane coatings and adhesives.

Another embodiment is an airbeam fabric for an aircraft escape slide or other airbeam application, constructed in a bi-directional manner as with a bi-directional weave such that the longitudinal strength of the fabric is approximately one half or less than 60% of the hoop strength of the fabric. Such a fabric may be constructed of nylon, polyester, aramid, para-aramid and/or liquid crystal polymer fibers and polyurethane coatings and adhesives. Or it may be constructed of nylon, polyester, aramid, para-aramid and/or liquid crystal polymer fibers and polyether polyurethane coatings and adhesives.

Yet another embodiment of the invention is an airbeam fabric with an average weight efficiency ratio greater than or equal to 60%, based on a safety factor of 4, using nylon fiber and baseline construction as elsewhere described herein for calculating the ratio. This embodiment may be constructed of nylon, polyester, aramid, para-aramid and/or liquid crystal polymer fibers and polyurethane coatings and adhesives; or it may be constructed of nylon, polyester, aramid, para-aramid and/or liquid crystal polymer fibers and polyether polyurethane coatings and adhesives. Other embodiments may have average weight efficiencies approximating 100% based on fiber and pitch selection to match FAA safety factor requirements. Other embodiments may have average weight efficiencies exceeding 200% based on use of high modulus fiber such as Vectran.

Yet another embodiment of the invention is an airbeam fabric with strength to weight ratios of greater than or equal to 35 hoop pounds per ounce of fabric and less than 20 axial pounds per ounce of fabric. This embodiment may be constructed of nylon, polyester, aramid, para-aramid and/or liquid crystal polymer fibers and polyurethane coatings and adhesives; or it may be constructed of nylon, polyester, aramid, para-aramid and/or liquid crystal polymer fibers and polyether polyurethane coatings and adhesives. This or other embodiments may have a strength to weight ratio greater than or equal to 40 hoop pounds per ounce of fabric and less than 25 axial pounds per ounce of fabric, or a strength to weight ratio greater than or equal to 50 hoop pounds per ounce of fabric and less than 30 axial pounds per ounce of fabric, or even a strength to weight ratio greater than or equal to 60 hoop pounds per ounce of fabric and less than 35 axial pounds per ounce of fabric.

A further embodiment of the invention is an airbeam fabric constructed such that the warp yarns are less than one half the denier of the fill yarns. The warp yarns may be less than one half the denier of the fill yarns and woven in groups of 2 or more yarns to improve the tear strength of the fabric in the warp direction.

Still another embodiment is an airbeam composite fabric constructed with less than 20% void content as determined by the optimum composite thickness method described above. This would include embodiments with less than 10% void content, and even less than 5%, as determined by the optimum composite thickness method.

Still further embodiments are an airbeam fabric constructed such that the warp cover factor is less than 80%, or 70%, or 60%, or even less than 50%.

While the above described embodiments relate particularly to aircraft escape slide airbeams and the special requirements applicable there, the principles described and claimed herein are applicable to any airbeam application. An airbeam structure is a flexible, inflatable airbag or fluid envelope of elongate proportions where its length is notably greater than its cord or diameter; the cord being the dimension of the cross section aligned with the load. The airbeam may be inflated with the same or a different fluid than the fluid medium in which it is placed. In use, it is inflated to a three dimensional, form-sustaining relatively high pressure with respect to the medium in which it is used. It is positioned to bridge at least two support points in support of a load. The support points may be spaced apart vertically or horizontally or at any angle inbetween. The load may be concentrated or distributed along the beam. The inflated structure functions in the broadest mechanical sense more as a beam subjected to bending stress between its support points, rather than as a mere post, ball, or cushion subjected to purely compressive loads.

An inflated airbeam structure may consist of a singular, beam-like component or elongate structure for supporting a load between two support points, or it may be a complex interconnected structure of airbeam components, or combination of airbeam and rigid components, such as a web, grid, radial or ladder-like structure, where the airbeam components are separately or commonly pressurized, the structure supported at two or more support points, the support points themselves may be points on other airbeams, while providing distributed load support to the fixed support points through its component interconnections.

In some airbeam structures, some airbeam components may function singularly or in addition to the beam function, as a lateral or vertical, compressive or tension member, such as for providing centering, and supplemental or overload weight bearing capacity. Rigid or inelastic components such as other compression, tension, belts, sheets, battens, and beam-like members, may connect to or interconnect airbeam components within an airbeam structure or to support points for a desired overall response of the airbeam structure to load conditions. All such simple and complex airbeam structures are within the scope of the invention. These and other derivative and related embodiments within the scope of the invention will be readily apparent to those skilled in the art from the description provided, and wherein the term “bi-directional fabric” means a fabric intentionally constructed to meet a complex load requirement where the strength requirement in one direction is different than in the cross direction.

For example, there is within the scope of the invention an inflatable airbeam suspendable between at least two support points, where the airbeam consists of a tubular fabric envelope made from a bi-directional fabric consisting of a cross machine fabric component made of fill fibers sized and configured for providing at least the required hoop strength to the airbeam; and a machine direction fabric component consisting of warp fibers sized and configured for providing at least the required longitudinal strength but less than the required hoop strength to the airbeam; with a coating applied to the fabric for reducing permeability.

The fabric envelope may be about 25 inches in diameter, and the bi-directional fabric may have a weight of not more than 6 oz/yd². The longitudinal strength may be less than 60% of the hoop strength. The bi-directional fabric may be a woven fabric where the weaving density of the warp fibers is less than 60% of of the weaving density of the fill fibers. The denier of the warp fibers may be less than 60% of the denier of the fill fibers. The warp fibers may be woven in groups of two or more yarns. The fabric may be constructed with less than 20% void content as determined by the optimum composite thickness method. The machine direction fabric component may consist of less than 45% of total fabric fiber content. And the airbeam may be part of an aircraft escape slide system.

The objects and advantages of the invention may be further realized and attained by means of the instrumentalities and combinations particularly pointed out in the appended claims. Accordingly, the drawing and description are to be regarded as illustrative in nature, and not as restrictive.

We claim:

1. An inflatable airbeam suspendable between at least two support points, said airbeam comprising a tubular fabric envelope made from a bi-directional fabric consisting of:
a cross machine fabric component comprising fill fibers sized and configured for providing at least the required hoop strength to said airbeam; and
a machine direction fabric component comprising warp fibers sized and configured for providing at least the required longitudinal strength but less than the required hoop strength to said airbeam;
a coating applied to said fabric for reducing permeability.

2. The airbeam of claim 1, said fabric envelope being about 25 inches in diameter, and said non-permeable, bi-directional fabric having a weight of not more than 6 oz/yd².

3. The airbeam of claim 1, wherein said longitudinal strength is less than 60% of said hoop strength.

4. The airbeam of claim 1, said bi-directional fabric being a woven fabric wherein the weaving density of said warp fibers is less than 60% of of the weaving density of said fill fibers.

5. The airbeam of claim 1, wherein material of said fibers is selected from the group of materials consisting of nylon, polyester, Vectran, aramid, para-aramid and liquid crystal polymer.

6. The airbeam of claim 1, said coating comprising a polyurethane material.

7. The airbeam of claim 1, wherein the denier of said warp fibers is less than 60% of the denier of said fill fibers.

8. The airbeam of claim 7, wherein said warp fibers are woven in groups of two or more yarns.

9. The airbeam of claim 1, wherein said fabric is constructed with less than 20% void content as determined by the optimum composite thickness method.

10. The airbeam of claim 1, wherein said machine direction fabric component comprises less than 45% of total fabric fiber content.

11. The airbeam of claim 1, configured as part of an aircraft escape slide system.

12. An airbeam constructed from a non-permeable, bi-directional fabric, said fabric comprising:
said airbeam having a nominal diameter of 25 inches;
fill fibers sized and configured for providing at least the required hoop strength of said airbeam; and
warp fibers sized and configured for providing at least the required longitudinal strength but less than the required hoop strength of said airbeam; and
a coating applied to said fabric, said fabric having a coated weight of not more than 6 oz/yd².

13. The airbeam of claim 12, wherein said longitudinal strength is less than 60% of said hoop strength, the material of said fibers is selected from the group of materials consisting of nylon, polyester, Vectran, aramid, para-aramid and liquid crystal polymer, and said coating comprises a polyurethane material.

14. The airbeam of claim 13, configured as part of an aircraft escape slide system.

15. A method for making an airbeam using a non-permeable, bi-directional fabric wherein the longitudinal strength requirement of said airbeam is less than its hoop strength requirement, comprising:
selecting a fabric configuration of warp and fill components for said bi-directional fabric wherein the fill component strength is at least equal to the hoop strength requirement and the warp component strength is at least equal to the longitudinal strength requirement but less than the hoop strength requirement, said warp and fill components each comprising fibers of a selected material, respective fiber size, configuration and end count;
weaving said warp and fill fibers according to said fabric configuration into an uncoated, bi-directional fabric;
coating said uncoated, bi-directional fabric with a polyurethane material to make it non-permeable; and
assembling said bi-directional fabric into an inflatable envelope of elongage proportions made resistant to bending by the pressure of inflation.

16. The method of claim 15, said uncoated fabric weighing less than 3 oz/yd².

17. The method of claim 16, said uncoated fabric having a thickness within a range extending from 0.0055 to 0.0065 inches.

18. The method of claim 16, said non-permeable, bi-directional fabric having a total thickness after coating of not more than 0.0069 inches and less than 20% void content as determined by the optimum composite thickness method.

19. The method of claim 18, said non-permeable, bi-directional fabric having a total weight after coating of not more than 6 oz/yd².

20. The method of claim 15, further comprising incorporating said airbeam into an aircraft escape slide.
